(19) United States
(12) Patent Application Publication
(10) Pub. No.: US 2014/0372803 A1
(43) Pub. Date: Dec. 18, 2014

(54) APPARATUS AND METHOD FOR ANALYZING ABNORMAL STATES OF COMPONENT-BASED SYSTEM

(71) Applicant: Electronics and Telecommunications Research Institute, Daejeon (KR)

(72) Inventors: Jeong-Min PARK, Seoul (KR); Sung-Joo KANG, Daejeon (KR); In-Geol CHUN, Seoul (KR); Won-Tae KIM, Asan-si Chungcheongnam-do (KR)

(73) Assignee: Electronics and Telecommunications Research Institute, Daejeon (KR)

(21) Appl. No.: 14/290,186

(22) Filed: May 29, 2014

(30) Foreign Application Priority Data
Jun. 12, 2013 (KR) 10-2013-0067310

(51) Int. Cl. G06F 11/07

(52) U.S. Cl. CPC G06F 11/079
USPC 714/37

(57) ABSTRACT

The present invention relates to an apparatus and method that analyze the problems of abnormal states in a component-based system in which embedded systems including an autonomous control function are operated. In the method, an apparatus for analyzing abnormal states of a component-based system models, interaction between components, and creates an interaction model. An incoming/outgoing message table corresponding to the interaction model is generated. A state table to be used to identify state changes between the components and an analysis table to be used to analyze other components associated with one component are generated based on the incoming/outgoing message table. A knowledge template of a target system is generated based on the state table and analysis table. Each component is monitored by applying constraint conditions of the component to the knowledge template of the target system, and states of the component are detected based on results of monitoring.

### CROSS REFERENCE TO RELATED APPLICATION

This application claims the benefit of Korean Patent Application No. 10-2013-0067310 filed on Jun. 12, 2013, which is hereby incorporated by reference in its entirety into this application.

### BACKGROUND OF THE INVENTION

1. Technical Field

The present invention relates generally to an apparatus and method for analyzing abnormal states of a component-based system and, more particularly, to an apparatus and method that analyze the problems of abnormal states in a component-based system in which a plurality of embedded systems including an autonomous control function are operated.

2. Description of the Related Art

Critical systems have become more and more complicated due to interactions between various components present therein. There are definite restrictions when human beings detect, analyze, and solve problems caused in such an environment, from the standpoint of available human resources and effective cost management. It is known that about 40% of all errors in computer systems are caused by manager errors, and thus there is a need to improve existing system management schemes that are dependent on professional managers.

In this way, it is a very important and difficult task for a human being to maintain and manage systems in a present complicated computer environment. In particular, in order to recognize problems occurring in systems and solve the recognized problems, a lot of effort and time are required. As a methodology for solving such problems, autonomous control technology is a field of research that is currently attracting attention.

Autonomous control technology is technology in which a system autonomously detects an unsuitable operation thereof and applies correct behavior to detected problems. Such autonomous control technology applies a monitoring step, an analysis step, a diagnosis step, a resolution step, and a reconfiguration step so as to secure reliability, robustness, and availability.

A monitoring step is configured to be able to identify the fault types of running critical software.

An analysis step is configured to be able to analyze fault types and determine whether to recover the faults depending on the degree of seriousness of problems.

A resolution step is configured to be able to select recovery strategies required to resolve caused problems.

A reconfiguration step is configured to be able to dynamically plan, arrange, and execute the configuration and behavior of a running critical system in conformity with recovery strategies.

Conventional research into such autonomous control technology may be classified into component-based, model-based, and log-based methodologies. The common problem of such conventional research is in that an autonomous control developer must personally analyze a target system having an unknown internal configuration. For example, in order to detect the abnormal states of a target system, constraint conditions must be modeled. In this case, the degree of autonomous control capability assigned to a target system may differ depending on the degree in which the autonomous control developer understands the target system.

Korean Patent No. 0763326 entitled “Method and apparatus for identifying basic causes and determining problems in a distributed system” presents a method for identifying one or more components related to the corresponding component, and searching for the states of components using a model capable of describing the life cycle (distribution, installation, and runtime) of one component.

However, since a conventional method for searching for the states of components is configured to diagnose causes when a specific condition is caused, a method of analyzing the problems of abnormal states using products generated at the step of designing the target system is required.

### SUMMARY OF THE INVENTION

Accordingly, the present invention has been made keeping in mind the above problems occurring in the prior art, and an object of the present invention is to provide an apparatus and method that analyze the problems of abnormal states in a component-based system in which a plurality of embedded systems including an autonomous control function are operated.

In accordance with an aspect of the present invention to accomplish the above object, there is provided a method for analyzing abnormal states of a component-based system, including modeling, by an apparatus for analyzing abnormal states of a component-based system, interaction between components, and creating an interaction model; generating an incoming/outgoing message table corresponding to the interaction model; generating a state table to be used to identify state changes between the components and an analysis table to be used to analyze other components associated with one component, based on the incoming/outgoing message table; generating a knowledge template of a target system based on the state table and the analysis table; and monitoring each component by applying constraint conditions of the component to the knowledge template of the target system, and detecting states of the component based on results of monitoring.

Preferably, detecting the states of the component may include determining status levels of the component corresponding to the states of the component; and providing executable strategies depending on the determined status levels of the component.

Preferably, generating the incoming/outgoing message table may be configured to analyze an incoming message and an outgoing message acquired via the interaction model, extract an incoming message identifier (ID), a component ID, an outgoing message ID, and a related component ID from results of analysis, and generate the incoming/outgoing message table based on results of extraction.

Preferably, the state table may include a current component ID, a state ID, an input state name, an incoming message ID, an entry action for causing a state transition to a current state, a current action performed upon causing a state transition, an outgoing message ID, an exit action for causing a state transition to a subsequent state, an output state name, and a component ID related to a state transition.

Preferably, the analysis table may include a current component ID, an ID of a component which transfers an incoming message, and an ID of a component to which an outgoing message is transferred.

In accordance with another aspect of the present invention to accomplish the above object, there is provided an apparatus for analyzing abnormal states of a component-based system, including an interaction model creation unit for modeling interaction between components in a component-based system, and creating an interaction model; an interaction analysis unit for generating an incoming/outgoing message table corresponding to the interaction model; a dependence analysis unit for generating a state table to be used to identify state changes between the components and an analysis table to be used to analyze other components associated with one component, based on the incoming/outgoing message table; a knowledge generation unit for generating a knowledge template of a target system based on the state table and the analysis table; and a component state detection unit for monitoring each component by applying constraint conditions of the component to the knowledge template of the target system, and detecting states of the component based on results of monitoring.

Preferably, the component state detection unit may determine status levels of the component corresponding to the states of the component, and provides executable strategies depending on the determined status levels of the component.

Preferably, the status levels of the component may include normal status, external abnormal status, internal abnormal status, and panic status.

Preferably, if the status level of the component is the external abnormal status, the component may be replaced with an available component, if the status level of the component is the internal abnormal status, a function factor of the component may be changed, and if the status level of the component is the panic status, a system manager may be called.

Preferably, the interaction analysis unit may analyze an incoming message and an outgoing message acquired via the interaction model, extract an incoming message identifier (ID), a component ID, an outgoing message ID, and a related component ID from results of analysis, and generate the incoming/outgoing message table based on results of extraction.

Preferably, the state table may include a current component ID, a state ID, an input state name, an incoming message ID, an entry action for causing a state transition to a current state, a current action performed upon causing a state transition, an outgoing message ID, an exit action for causing a state transition to a subsequent state, an output state name, and a component ID related to a state transition.

Preferably, the analysis table may include a current component ID, an ID of a component which transfers an incoming message, and an ID of a component to which an outgoing message is transferred.

The present invention is advantageous in that, in a component-based system in which a plurality of embedded systems including an autonomous control function are operated, an autonomous control developer does not need to personally analyze a target system having an unknown internal configuration, and thus the problems of abnormal states may be analyzed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram schematically showing an apparatus for analyzing abnormal states of a component-based system according to an embodiment of the present invention;

FIG. 2 is a diagram showing an interaction model created by a participant according to an embodiment of the present invention;

FIG. 3 is a diagram illustrating an interaction model created by an interaction model creation unit according to an embodiment of the present invention;

FIG. 4 is a diagram showing the incoming/outgoing message table of a receiver-side component according to an embodiment of the present invention;

FIG. 5 is a diagram showing a state table according to an embodiment of the present invention;

FIG. 6 is a diagram showing an analysis table according to an embodiment of the present invention;

FIG. 7 is a diagram showing the knowledge template of a target system according to an embodiment of the present invention;

FIG. 8 is a diagram showing individual pieces of information of each component according to an embodiment of the present invention;

FIG. 9 is a diagram showing knowledge indicating the association between components according to an embodiment of the present invention.

FIG. 10 is a diagram showing an environment monitored by a component state detection unit according to an embodiment of the present invention;

FIG. 11 is a diagram showing the states of components according to an embodiment of the present invention;

FIG. 12 is a diagram showing the status levels of a component according to an embodiment of the present invention;

FIG. 13 is a diagram showing executable strategies depending on the status levels of a component according to an embodiment of the present invention; and

FIG. 14 is a flowchart showing a method of analyzing abnormal states of a component-based system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, an apparatus and method for analyzing abnormal states of a component-based system of an embedded system distributed to a real operating environment and being operated therein according to embodiments of the present invention will be described in detail with reference to the attached drawings.

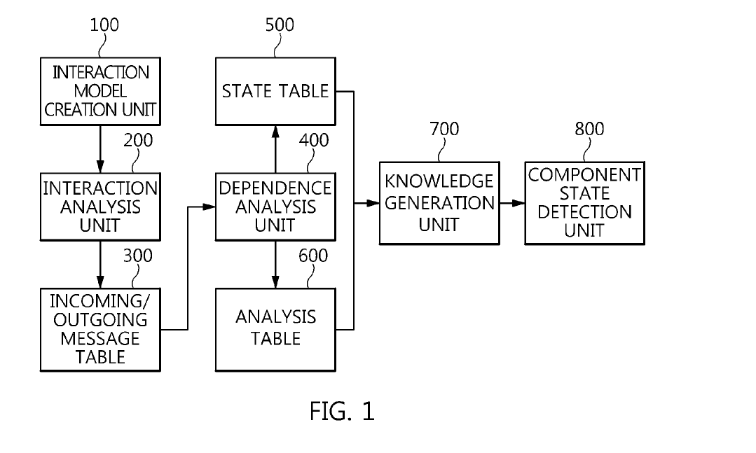

FIG. 1 is a diagram schematically showing an apparatus for analyzing abnormal states of a component-based system according to an embodiment of the present invention.

Referring to FIG. 1, an apparatus for analyzing abnormal states of a component-based system includes an interaction model creation unit 100, an interaction analysis unit 200, an incoming/outgoing message table 300, a dependence analysis unit 400, a state table 500, an analysis table 600, a knowledge generation unit 700, and a component state detection unit 800.

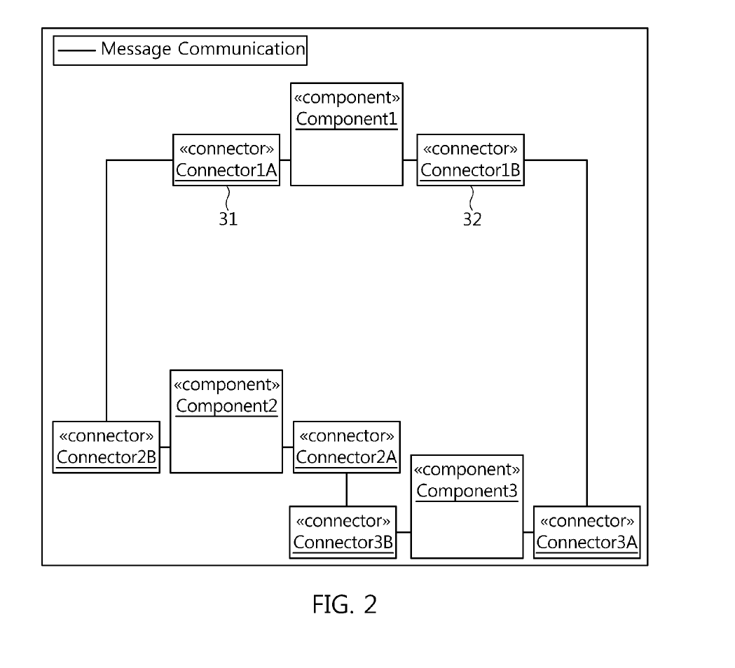

The interaction model creation unit 100 allows a participant, for example, a requirement deriver or a system designer, to model the interaction of a target system. In this case, the interaction model created by the participant is illustrated in FIG. 2.

Referring to FIG. 2, in a component-based system, one component provides a functional service to other components, and each component includes an input connector and an output connector. For example, component 1 is connected to an input connector (Connector 1A) 31 and an output connector (Connector 1B) 32.

Each component receives an incoming message for a service request through an input connector (Connector A), and outputs an outgoing message for a service response through an output connector (Connector B).

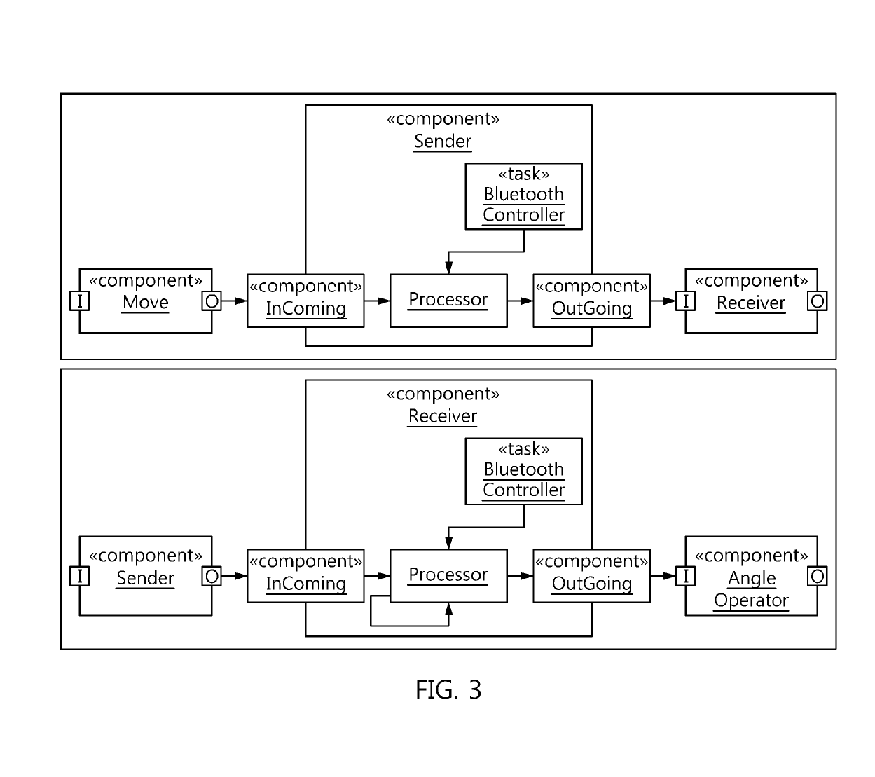

FIG. 3 illustrates an example of the interaction model created by the interaction model creation unit 100.

The interaction analysis unit 200 receives the interaction model created by the interaction model creation unit 100 and generates an incoming/outgoing message table 300 corresponding to the interaction model.

In detail, the interaction analysis unit 200 analyzes an incoming message and an outgoing message acquired via the interaction model of FIG. 3, and extracts an incoming message identifier (ID), a component ID, an outgoing message ID, and a related component ID from the results of the analysis of the messages.

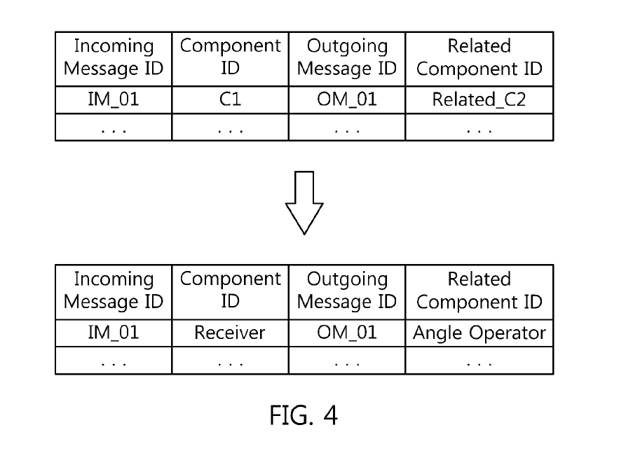

FIG. 4 illustrates the incoming/outgoing message table of the receiver-side component of FIG. 3.

Referring to FIG. 4, the receiver-side component receives an incoming message IM_{—}01 and transfers an outgoing message OM_{—}01 to an angle operator. By means of this procedure, the component incoming/outgoing messages are analyzed.

The dependence analysis unit 400 analyzes the association between components based on the incoming/outgoing message table 300 generated by the interaction analysis unit 200. Then, the dependence analysis unit 400 identifies other components to which one component is connected via the incoming/outgoing messages, based on the results of the analysis of the association between the components.

The dependence analysis unit 400 generates a state table 500 and an analysis table 600 based on the received incoming/outgoing message table 300. Here, the state table 500 is used to identify state changes between components, and the analysis table 600 is used to analyze other components associated with one component.

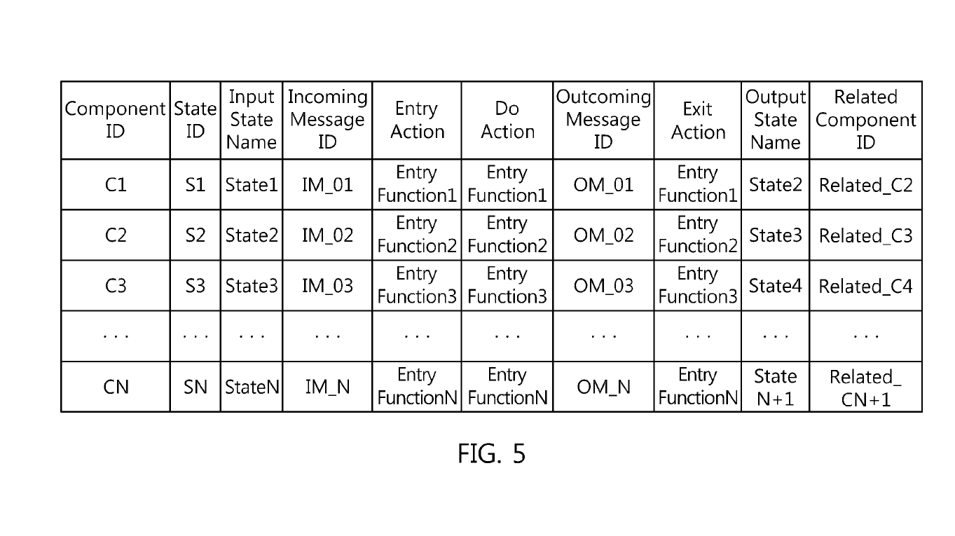

Next, the state table 500 may be represented, as shown in FIG. 5.

Referring to FIG. 5, the state table 500 includes a current component identifier (Component ID), a state identifier (State ID), an input state name (Input State Name), an incoming message identifier (Incoming Message ID), an action for causing a state transition to a current state S1 (Entry Action), a current action performed upon causing a state transition (Do Action), an outgoing message identifier (Outgoing Message ID), an action for causing a state transition to a subsequent state S2 (Exit Action), an output state name (Output State Name), and a component identifier related to a state transition (Related Component ID).

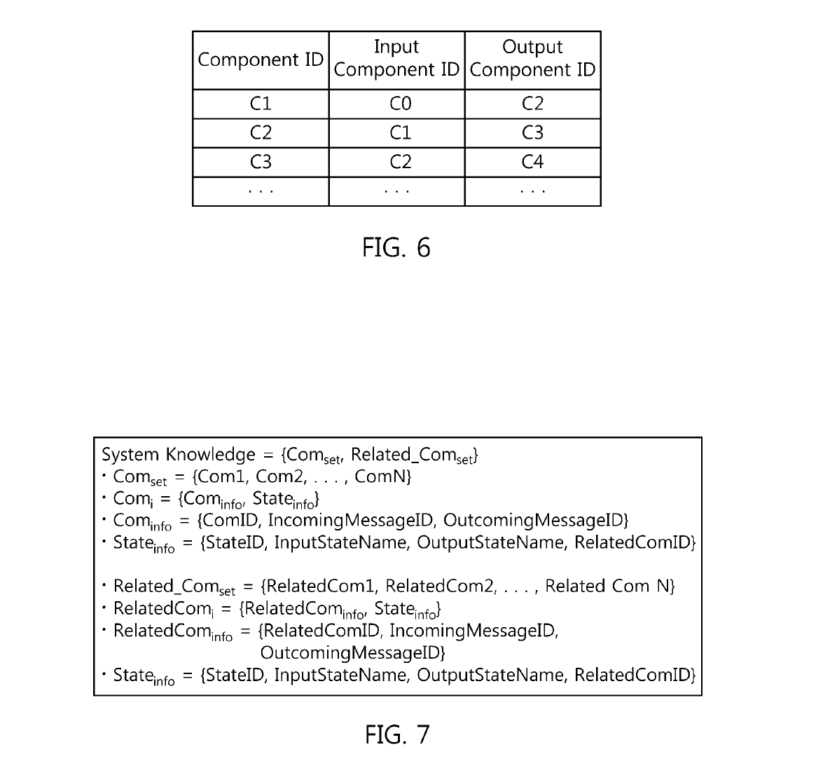

Meanwhile, the analysis table 600 may be represented, as shown in FIG. 6.

Referring to FIG. 6, the analysis table 600 indicates an input component and an output component on the basis of a current component. For this, the analysis table 600 includes a current component identifier (Component ID), the ID of a component which transfers an incoming message (Input Component ID), and the ID of a component to which an outgoing message is transferred (Output Component ID).

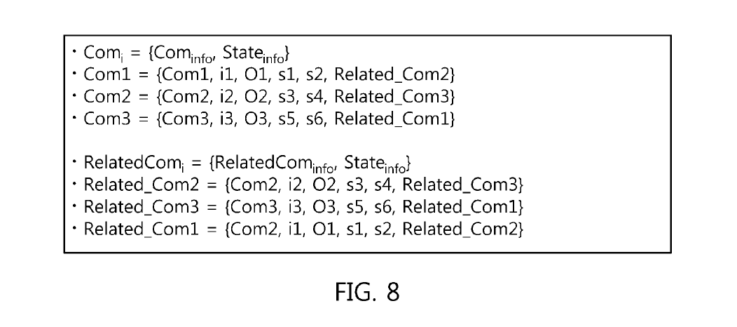

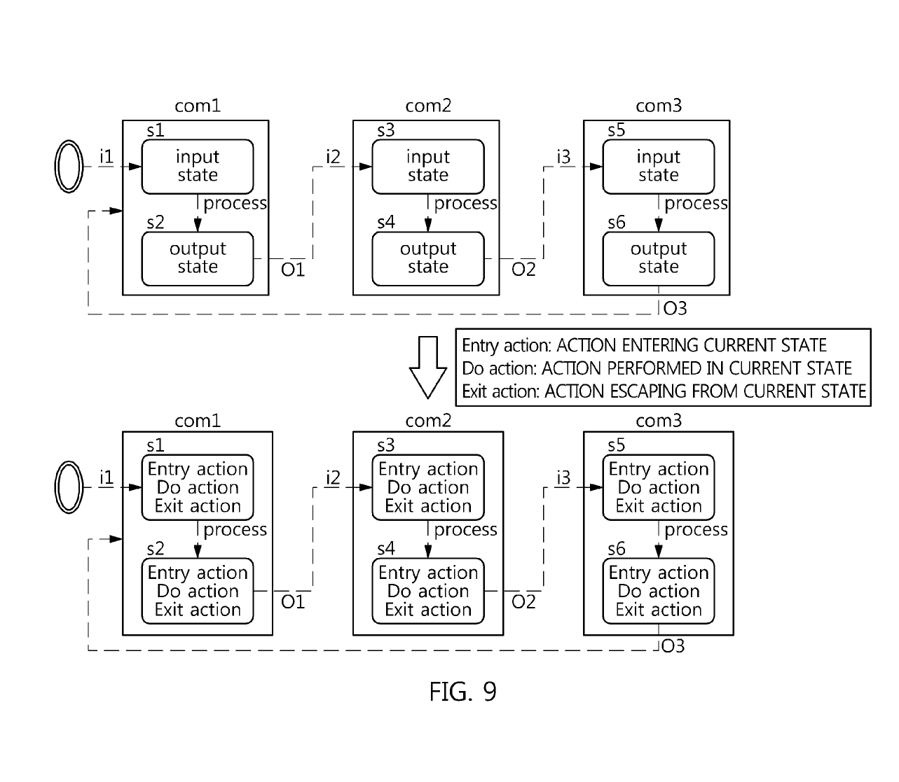

The knowledge generation unit 700 generates the knowledge of a target system (system knowledge) based on the state table 500 and the analysis table 600 generated by the dependence analysis unit 400. For example, the knowledge generation unit 700 generates the knowledge template of the target system based on the state table 500 and the analysis table 600, as shown in FIG. 7. In this case, individual pieces of information are designated for each component using the knowledge template, as shown in FIG. 8, and knowledge indicating the association between components is schematized and generated, as shown in FIG. 9.

The component state detection unit 800 monitors the input and output states of each component using the constraint conditions of the component (for example, time restrictions or the like). The component state detection unit 800 may generate abnormal status levels of the corresponding component based on the results of the monitoring.

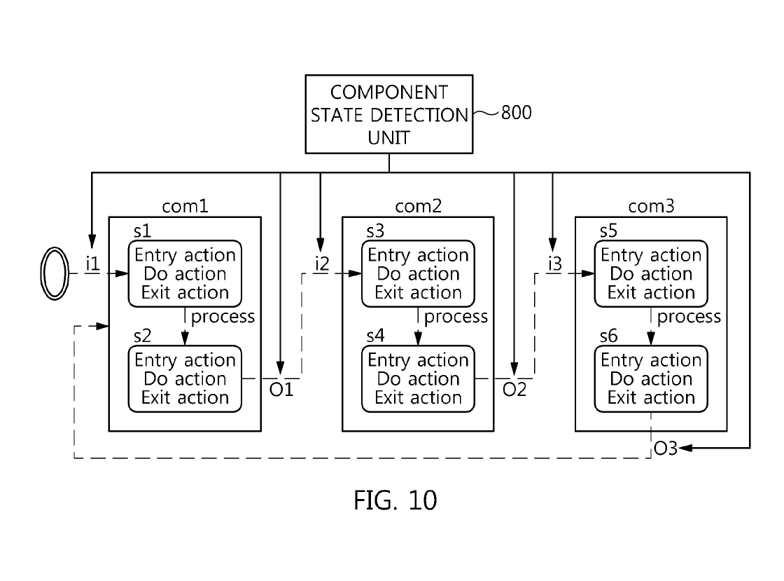

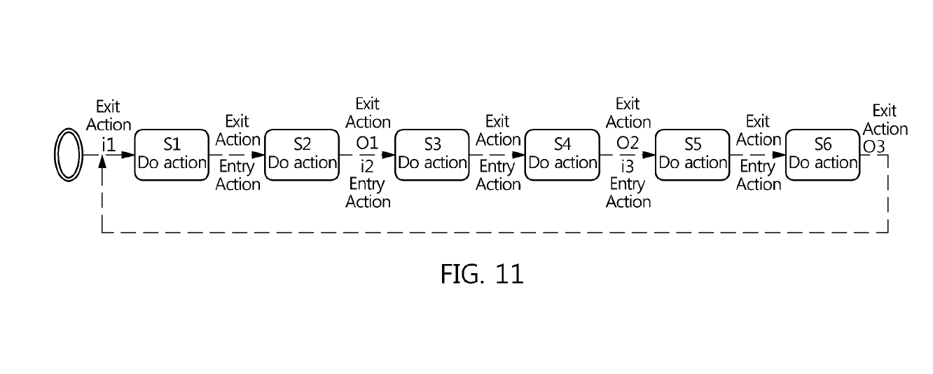

Referring to FIG. 10, the component state detection unit 800 monitors the inputs i1, i2, and i3 and the outputs o1, o2, and o3 of components, and determines whether the states s1, s2, s3, s4, s5, and s6 of the components are normal or abnormal, based on the results of the monitoring. The states of the components are represented, as shown in FIG. 11.

Referring to FIG. 11, an entry action required to enter a current state and an exit action required to escape from the current state are events capable of causing a state transition, and thus such actions may be monitored by the component state detection unit 800. Further, the component state detection unit 800 may determine whether the individual states of each component are normal or abnormal when problems occur in events.

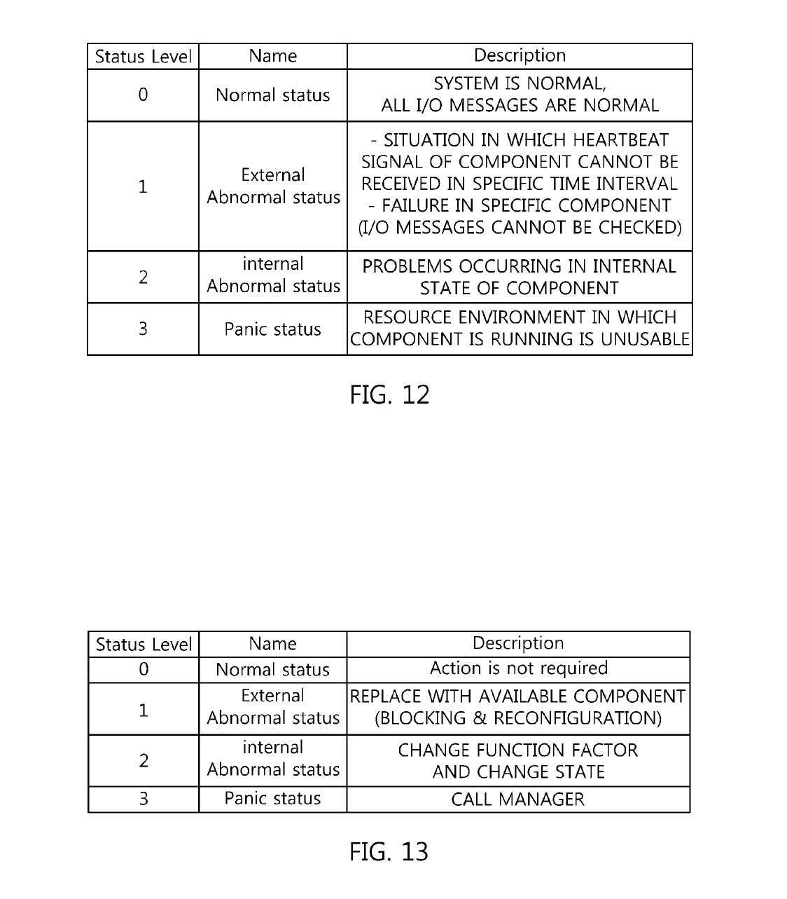

As shown in FIG. 12, the component state detection unit 800 may represent the status levels of the corresponding component. The status levels of the component include normal status, external abnormal status, internal abnormal status, and panic status.

Further, the component state detection unit 800 provides executable strategies, as shown in FIG. 13, depending on the status levels of the component, such as those shown in FIG. 12.

Referring to FIG. 13, in normal status, no strategy is provided. In external abnormal status, a component may be replaced with an available component. In internal abnormal status, a function factor is changed and the state is changed. Further, in panic status, a system manager is called.

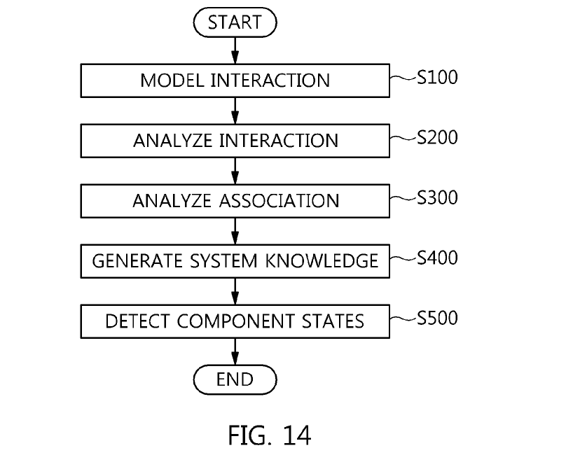

Hereinafter, a method of analyzing abnormal states of a component-based system will be described in detail with reference to FIG. 14.

FIG. 14 is a flowchart showing a method of analyzing abnormal states of a component-based system according to an embodiment of the present invention.

Referring to FIG. 14, the apparatus for analyzing the abnormal states of the component-based system (hereinafter also referred to as an “abnormal state analysis apparatus”) allows a participant, for example, a requirement deriver or a system designer, to model the interaction of a target system and create an interaction model at step S100. The interaction model created at step S100 is shown in FIG. 3.

In the component-based target system, one component provides a functional service to other components, and each component includes an input connector and an output connector. In this way, the results of modeling the interactions between the components and between the input connectors and output connectors corresponding to the components are regarded as the interaction model.

The abnormal state analysis apparatus generates an incoming/outgoing message table 300 corresponding to the interaction model, created at step S100, at step S200.

In detail, the abnormal state analysis apparatus analyzes an incoming message and an outgoing message acquired via the interaction model of FIG. 3, and extracts an incoming message ID, a component ID, an outgoing message ID, and a related component ID from the results of the analysis. Thereafter, the abnormal state analysis apparatus generates the incoming/outgoing message table 300 based on the extracted IDs.

The abnormal state analysis apparatus generates a state table 500 and an analysis table 600 based on the incoming/outgoing message table 300 generated at step S200, and analyzes the association between components based on the tables S300. The state table 500 generated at step S300 is used to identify state changes between components, and the analysis table 600 is used to analyze other components associated with one component. Further, the state table 500 and the analysis table 600 are respectively illustrated in FIGS. 5 and 6.

The abnormal state analysis apparatus generates the knowledge of the target system (system knowledge) based on the state table 500 and the analysis table 600, generated at step S300, at step S400. Here, the system knowledge may be generated in a form such as that shown in FIG. 7, that is, the knowledge template of the system. In this case, individual pieces of information are designated for each component using the knowledge template, as shown in FIG. 8, and the knowledge indicating the association between components is schematized and generated, as shown in FIG. 9.

The abnormal state analysis apparatus monitors the input and output states of each component using the knowledge of the target system generated at step S400 and the constraint conditions of the component, and detects the state of the component based on the results of the monitoring at step S500. In this case, the abnormal state analysis apparatus monitors the inputs i1, i2, and i3 and the outputs o1, o2, and o3 of components, and determines whether the states s1, s2, s3, s4, s5, and s6 of the components are normal or abnormal, based on the results of the monitoring. Here, the states of the components are represented, as shown in FIG. 11.

Referring to FIG. 11, an entry action required to enter a current state and an exit action required to escape from the current state are events capable of causing a state transition, and thus such actions may be monitored by the component state detection unit 800. Further, the component state detection unit 800 may determine whether the individual states of each component are normal or abnormal when problems occur in events.

Further, the abnormal state analysis apparatus may represent the status levels of each component, as shown in FIG. 12. The status levels of the component include normal status, external abnormal status, internal abnormal status, and panic status. The abnormal state analysis apparatus provides executable strategies, as shown in FIG. 13, depending on the status levels of the component, such as those shown in FIG. 12.

As described above, the present invention is advantageous in that, in a component-based system in which a plurality of embedded systems including an autonomous control function are operated, an autonomous control developer does not need to personally analyze a target system having an unknown internal configuration, and thus the problems of abnormal states may be analyzed.

In the above description, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A method for analyzing abnormal states of a component-based system, comprising:
modeling, by an apparatus for analyzing abnormal states of a component-based system, interaction between components, and creating an interaction model;
generating an incoming/outgoing message table corresponding to the interaction model;
generating a state table to be used to identify state changes between the components and an analysis table to be used to analyze other components associated with one component, based on the incoming/outgoing message table;
generating a knowledge template of a target system based on the state table and the analysis table; and
monitoring each component by applying constraint conditions of the component to the knowledge template of the target system, and detecting states of the component based on results of monitoring.

2. The method of claim 1, wherein detecting the states of the component comprises:
determining status levels of the component corresponding to the states of the component; and
providing executable strategies depending on the determined status levels of the component.

3. The method of claim 1, wherein generating the incoming/outgoing message table is configured to analyze an incoming message and an outgoing message acquired via the interaction model, extract an incoming message identifier (ID), a component ID, an outgoing message ID, and a related component ID from results of analysis, and generate the incoming/outgoing message table based on results of extraction.

4. The method of claim 1, wherein the state table comprises a current component ID, a state ID, an input state name, an incoming message ID, an entry action for causing a state transition to a current state, a current action performed upon causing a state transition, an outgoing message ID, an exit action for causing a state transition to a subsequent state, an output state name, and a component ID related to a state transition.

5. The method of claim 1, wherein the analysis table comprises a current component ID, an ID of a component which transfers an incoming message, and an ID of a component to which an outgoing message is transferred.

6. An apparatus for analyzing abnormal states of a component-based system, comprising:
an interaction model creation unit for modeling interaction between components in a component-based system, and creating an interaction model;
an interaction analysis unit for generating an incoming/outgoing message table corresponding to the interaction model;
a dependence analysis unit for generating a state table to be used to identify state changes between the components and an analysis table to be used to analyze other components associated with one component, based on the incoming/outgoing message table;
a knowledge generation unit for generating a knowledge template of a target system based on the state table and the analysis table; and
a component state detection unit for monitoring each component by applying constraint conditions of the component to the knowledge template of the target system, and detecting states of the component based on results of monitoring.

7. The apparatus of claim 6, wherein the component state detection unit determines status levels of the component corresponding to the states of the component, and provides executable strategies depending on the determined status levels of the component.

8. The apparatus of claim 7, wherein the status levels of the component comprise normal status, external abnormal status, internal abnormal status, and panic status.

9. The apparatus of claim 8, wherein:
if the status level of the component is the external abnormal status, the component is replaced with an available component,
if the status level of the component is the internal abnormal status, a function factor of the component is changed, and
if the status level of the component is the panic status, a system manager is called.

10. The apparatus of claim 6, wherein the interaction analysis unit analyzes an incoming message and an outgoing message acquired via the interaction model, extracts an incoming message identifier (ID), a component ID, an outgoing message ID, and a related component ID from results of analysis, and generates the incoming/outgoing message table based on results of extraction.

11. The apparatus of claim 6, wherein the state table comprises a current component ID, a state ID, an input state name, an incoming message ID, an entry action for causing a state transition to a current state, a current action performed upon causing a state transition, an outgoing message ID, an exit action for causing a state transition to a subsequent state, an output state name, and a component ID related to a state transition.

12. The apparatus of claim 6, wherein the analysis table comprises a current component ID, an ID of a component which transfers an incoming message, and an ID of a component to which an outgoing message is transferred.
